(19) United States
(12) Patent Application Publication
(10) Pub. No.: US 2004/0165290 A1
(43) Pub. Date: Aug. 26, 2004

(54) Reflective heating and lighting device

(76) Inventor: Jean Muscat, McHenry, IL (US)

Correspondence Address: Douglas B. White, 1000 East Woodfield Road, Suite 102, Schaumburg, IL, 60173, US

(21) Appl. No.: 10/370,948

(22) Filed: Feb. 21, 2003

(51) Int. Cl. G02B 5/08

(52) U.S. Cl. 359/850; 359/597

(57) ABSTRACT

Passive reflective members in the form of panels or mirrors are mounted to a building for providing reflection of light and solar radiation. The reflective members are mounted along the buildings on adjustable brackets. Further, there is described a design for a storage building complex where these buildings present reflective panels for reflecting sunlight and enhancing electrical lighting within the aisles between the buildings.

### STATEMENT REGARDING FEDERALLY SPONSORED RESEARCH OR DEVELOPMENT

Not Applicable

### CROSS REFERENCE TO RELATED APPLICATIONS

Not Applicable

### BACKGROUND OF THE INVENTION

1. Field of the Invention

The present invention relates generally to the field of heating and lighting. More particularly, this invention relates to passive means for providing and enhancing heating and lighting on the exterior of buildings.

2. Description of the Prior Art

It is well known that buildings generally present a shady side, and in much of the northern United States this shady (northerly) side of the buildings is notorious for the build-up of snow and ice during the winter months. As a result, snow and ice must be manually removed much more often and more extensively on the northern side of the buildings to assure safe, unimpeded access to the buildings, all at considerable expense. This snow and ice removal is even more of a problem where there are multiple closely spaced buildings, such as is usually found in the complex of buildings typically employed for public self storage. In such a storage building complex one finds rows of buildings all aligned along narrow aisles of 25 feet to 30 feet in width, thereby making snow and ice removal at the same time more important yet more difficult.

Another well known problem of building operation and maintenance is the difficulty and expense of providing adequate lighting for safety and security. Floodlights and spotlights are generally mounted to the buildings or other appropriate structures and positioned to illuminate the grounds. Unfortunately, this requires a large number of lights and a lot of power (and the associated expense) to operate these lights. And even then, there will be shadows where visibility is diminished.

No prior art device has been proposed which will both aid snow and ice removal around buildings and, at the same time, will improve the effectiveness and efficiency of the lighting applied to the buildings.

### SUMMARY OF THE INVENTION

Accordingly, it is the principal objective of the present invention to provide a passive heating device for assisting in the snow and ice removal around buildings, which device is both effective and environmentally friendly.

It is a further objective of the present invention to provide a passive device that will improve the effectiveness and efficiency of the lighting around buildings while also conserving power.

It is yet a further objective to provide a new building design for a storage building complex that includes inexpensive passive enhancement of the exterior heating and lighting.

The present invention accomplishes these and other objectives by providing a reflective device positioned along the side of a building. During the daytime this device reflects sunlight toward the shady side of the nearby buildings, thereby providing passive heating during the winter months for melting the snow and ice. During the night, the same reflective panel reflects light from nearby floodlights to illuminate the aisles between the buildings, thereby enhancing the efficiency and coverage of the lighting.

In accordance with the present invention there is provided one or more passive reflective members mounted to a building for reflecting light and solar radiation. These reflective members, in the preferred embodiment, present curved mirror-like surfaces to maximize the target area being heated and illuminated. In one embodiment, the reflective member is a curved panel mounted along the length of the building and positioned to reflect light and solar radiation towards a target area. Alternate embodiments for the reflective member include a plurality of panel segments or convex mirrors.

In a further embodiment of the invention, there is described a design for storage buildings employed in multiple rows for self storage. These buildings present a reflective member, or members, along their sides for reflecting sunlight and enhancing applied electrical lighting into a target aisle area between the buildings.

### BRIEF DESCRIPTION OF THE DRAWINGS

FIG. 1 is a perspective view of rows of building in accordance with the present invention having a passive reflective panel mounted thereto.

FIG. 2 is a diagrammatic view illustrating the reflection process of the present invention redirecting heat and light to a target area between the buildings.

FIG. 3 is a detail, cross sectional, view showing a reflective device in accordance with the present invention affixed to a building.

FIG. 4 is a perspective view depicting an alternate embodiment of the invention.

FIG. 5 is a perspective view depicting another alternate embodiment of the invention.

While the invention will be described in connection with a preferred embodiment, it will be understood that it is not the intent to limit the invention to that embodiment. On the contrary, it is the intent to cover all alternatives, modifications, and equivalents as may be included within the spirit and scope of the invention as defined by the appended claims.

### DESCRIPTION OF THE PREFERRED EMBODIMENT

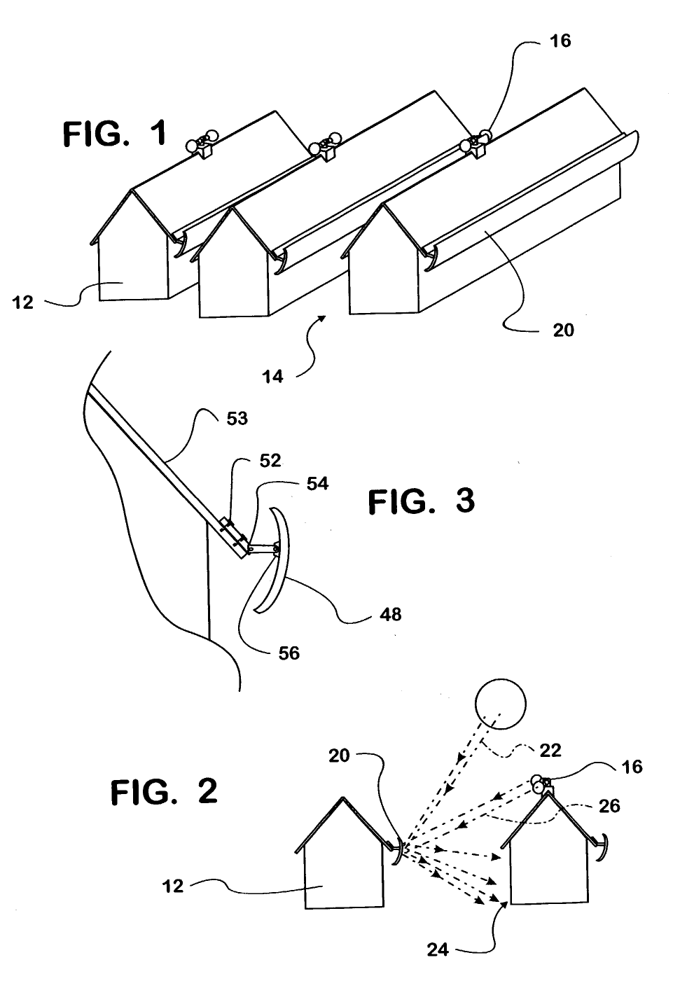

Turning first to FIG. 1 there are shown multiple rows of storage buildings 12 having aisles 14 defined between them and forming a storage building complex. Mounted to each of these buildings are one or more light fixtures 16, such as floodlights, spotlights or the like. These lights may be mounted to any convenient location other than, or in addition to, the top of the buildings, such as along the side of the buildings in the aisle 14, all within the scope of this invention.

Mounted to selected buildings (as described below) along the aisles 14, is a reflective member 20. In the preferred embodiment, this reflective member is mounted to the building at such an angle that, during the daytime, the sunlight 22 will reflect off of the reflective member 20, as hereinafter described. In accordance with this invention the reflective member 20 is positioned so that the reflection of the solar radiation impinges on a target area 24 (see FIG. 2) defined within the aisle 14 (usually by the shady side of the neighboring building). Similarly, light 26 emanating from the light fixtures 16 is also reflected by the reflective member 20 to provide passive illumination to the defined target area 24.

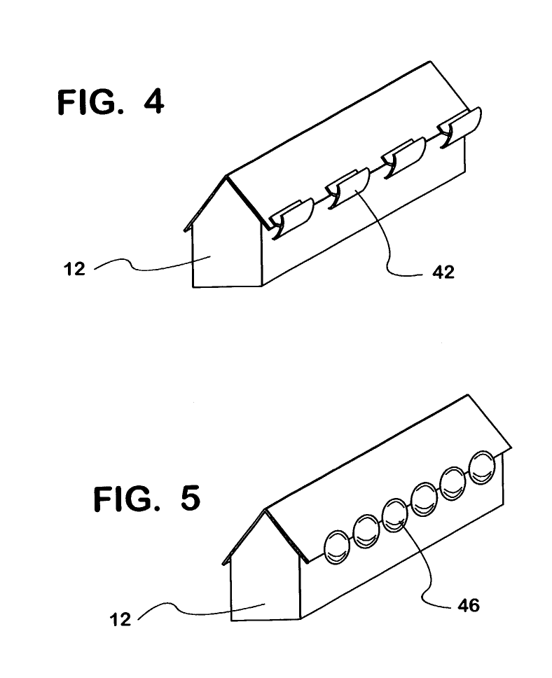

The reflective member 20, in one embodiment (see FIG. 1), is an elongated curved panel that traverses the length of the building. Alternatively (see FIG. 4), the reflective member may consist of a series of reflector panel segments 42 (FIG. 4) or a series of mirrors 46 (FIG. 5) distributed along the side of the buildings. In either embodiment, the reflective member 20 preferably presents a highly reflective surface 48 (FIG. 3), which surface may be polished metal, mirrored glass, or other equivalent reflective surface.

With either embodiment, the reflective member 20 is mounted firmly to the building, as shown in FIG. 3. This mounting consists of a bracket 52 attached to the roof 53, as shown in FIG. 3, or alternatively attached to a gutter or the side of the building, all within the scope of this invention. Additionally, this bracket 52 also includes adjustment joints 54 and 56 to assist in the positioning and aiming of the reflective device for the most effective reflection onto the defined target area 24.

From the foregoing description, it will be apparent that modifications can be made to the apparatus and method for using same without departing from the teachings of the present invention. Accordingly, the scope of the invention is only to be limited as necessitated by the accompanying claims.

What is claimed is:

1. A reflective device for a building comprising:
a reflective member affixed to the building and positioned to reflect sunlight towards a target area, whereby said reflective member provides passive solar heating to said target area.

2. The reflective device of claim 1 wherein said reflective member is further positioned to reflect illumination toward said target area, whereby said reflective member provides passive reflected lighting to said target area.

3. The reflective device of claim 1 wherein said reflective member comprises one or more panels mounted along the building.

4. The reflective device of claim 1 wherein said reflective member comprises a plurality of mirrors mounted along the building.

5. The reflective device of claim 1 wherein said target area is defined within an aisle between buildings.

6. The reflective device of claim 1 wherein said reflective member is mounted to said building by an adjustable bracket.

7. The reflective device of claim 6 wherein said reflective member is further positioned to reflect illumination toward a target area, whereby said reflective member provides passive lighting to said target area.

8. The reflective device of claim 6 wherein said reflective member comprises one or more panels mounted along the building.

9. The reflective device of claim 6 wherein said reflective member comprises a plurality of mirrors mounted along the building.

10. The reflective device of claim 6 wherein said target area is defined within an aisle between buildings.

11. A storage building complex comprising:
rows of storage buildings; and
reflective members mounted to selected buildings and positioned to reflect sunlight to target areas, whereby said reflective members provide passive solar heating to said target area.

12. The storage building complex of claim 11 wherein said reflective members are further positioned to reflect illumination toward target areas, whereby said reflective members provide passive reflected lighting on said target areas.

13. The storage building complex of claim 11 wherein said reflective members comprise one or more reflective panels mounted along the building.

14. The storage building complex of claim 11 wherein said reflective members comprise a plurality of mirrors mounted along the building.

15. The storage building complex of claim 11 wherein said target areas are defined within aisles between buildings.

16. The storage building complex of claim 11 wherein said reflective members are mounted to said building by adjustable brackets.

17. The storage building complex of claim 16 wherein said reflective members are further positioned to reflect illumination toward target areas, whereby said reflective members provide passive reflected lighting on said target areas.

18. The storage building complex of claim 16 wherein said reflective members comprise one or more reflective panels mounted along the building.

19. The storage building complex of claim 16 wherein said reflective members comprise a plurality of mirrors mounted along the building.

20. The storage building complex of claim 16 wherein said target areas are defined within aisles between buildings.
